(19) United States
(12) Patent Application Publication
(10) Pub. No.: US 2006/0166348 A1
(43) Pub. Date: Jul. 27, 2006

(54) Anaerobic biological degradation of hydrocarbons

(76) Inventors: Jan Gerritse, Apeldoorn (NL); Hendrik Ballerstedt, Arnhem (NL); Alette Anna Maria Langenhoff, Wageningen (NL); Hubertus Henricus Martinus Rijnaarts, Nijmegen (NL)

Correspondence Address: YOUNG & THOMPSON, 745 SOUTH 23RD STREET, 2ND FLOOR, ARLINGTON, VA, 22202, US

(21) Appl. No.: 10/527,409

(22) PCT Filed: Sep. 12, 2003
(86) PCT No.: PCT/NL03/00632

§ 371 Date: Dec. 27, 2005

(30) Foreign Application Priority Data
Sep. 13, 2002 (NL) 1021458

(51) Int. Cl. C05F 11/08; B09C 1/10

(52) U.S. Cl. 435/262.5; 71/6

(57) ABSTRACT

The invention relates to a method for the anaerobic biological degradation of aromatic hydrocarbons (in particular benzene), and to a specific mixture and the use thereof for this degradation. According to the invention, the anaerobic biological degradation of aromatic hydrocarbons present at a contaminated location is stimulated and stabilized by the use of a combination of humic acids and/or anthraquinone-2,6-disulfate and nitrate, which is added to anaerobic bacterial populations.

The invention relates to a method for the anaerobic biological degradation of hydrocarbons, specifically aromatic and aliphatic hydrocarbons, and to a specific mixture and the use thereof for this degradation.

In soil remediations, for the purpose of degradation of aromatic hydrocarbons, such as benzene, typically use is made of aerobic degradation. The net reaction equation for this degradation can be represented (for benzene) as follows:
2C₆H₆+15O₂ →12CO₂+6H₂O (1)

Compressed air injection is the most commonly used method to effect such degradation. In addition, methods are known where oxygen release compounds (ORC) are introduced into the soil. Examples of such components are hydrogen peroxide, ozone and solids such as magnesium peroxide (MgO₂). The methods in which oxygen-bearing components are introduced into the soil are deployed in particular on a smaller scale but have as a drawback that the components mentioned are chemically unstable and/or have a minor bioavailability.

Especially in deep soil systems, certainly if these have a complex structure, the introduction of oxygen is costly, inefficient and difficult to carry out.

U.S. Pat. No. 6,432,693 discloses a method for the anaerobic degradation of halogenated organic contaminants and the oxidized forms of organic contaminants. To that end, a specific solids mixture of metals is used. Because the solids mixture from U.S. Pat. No. 6,432,693 apparently has difficulty remaining in solution, it is proposed in that patent publication to use a chelating agent. As one of the chelating agents, U.S. Pat. No. 6,432,693 suggests humic acid, which is capable of binding to the dosed metals and can bring them into solution.

Although anaerobic degradation of benzene has been demonstrated in soils, it has been found that this degradation capacity is not present in many locations. At locations where the anaerobic degradation does occur, the process proceeds, for instance, according to the following net reaction equations, wherein nitrate, iron, and sulfate, respectively, act as electron acceptor:
C₆H₆+6HNO₃ →6CO₂+3N₂+6H₂O (2)
C₆H₆+30Fe(OH)₃→6CO₂+30FeO+30H₂O (3)
4C₆H₆+15H₂SO₄→24CO₂+15H₂S+12H₂O (4)

However, the reaction rates of anaerobic degradation (2-4) are orders of magnitude lower than those of aerobic degradation (1). There is only little known about the mechanisms of anaerobic degradation of benzene and the bacteria involved in this process. As a consequence, techniques that reproducibly result in a fast and stable anaerobic benzene degradation are lacking, which constitutes a considerable limitation to the development of biological soil remediation of sites contaminated with benzene and other aromatic hydrocarbons. Accordingly, there is a need for alternative methods for the degradation of benzene and other aromatic hydrocarbons.

During experiments in a laboratory bioreactor in which an anaerobic culture medium was passed through continuously, it was surprisingly found that through the use of a specific mixture of at least one electron acceptor and one or more humic acids, this need can be met. Accordingly, the present invention relates to a method for the anaerobic biological degradation of aromatic hydrocarbons, wherein a combination of humic acids and nitrate is added to an anaerobic bacterial population.

The anaerobic bacterial populations, which take care of the degradation of the aromatic hydrocarbons, occur naturally in the soil and in groundwater. What is achieved by dosing the mixture of nitrate and humic acids according to the invention is that the degradation of benzene and other aromatics is stimulated and stabilized under nitrate-reducing anaerobic conditions. A major advantage of the instant finding is that for the biodegradation of hydrocarbons in deep anaerobic soil systems, even if they have a complex structure, the costly, inefficient, and cumbersome introduction of oxygen is not necessary anymore.

A very suitable electron acceptor is nitrate, because it is water soluble, and hence properly doseable in practice, without precipitates being formed. Moreover, nitrate is a very strong electron acceptor. Not only nitrate, but also other nitrogenous compounds are eligible, in particular intermediates from the reduction of nitrate, such as nitrite and dinitrogen monoxide (N₂O). In this connection, it is noted that in reaction (2) above, it is not necessarily nitrogen that is formed. It is also possible that nitrite, N₂O or ammonium (NH₄+) is formed. Nitrite and N₂O in turn can function as electron acceptor.

Further, metal ions, such as Fe(III) and Mn(IV), can be used as electron acceptor. However, the drawback involved is that they form precipitates and hence are difficult to dose. Moreover, these metals remain present in the soil. For this reason, the electron acceptor is preferably not based on iron nor on manganese. In particular, the electron acceptor preferably does not comprise metallic iron, metallic manganese and/or manganese salts. More preferably, the electron acceptor is a non-metallic electron acceptor.

Also sulfate can be used as electron acceptor, but sulfate is reduced to sulfide (see reaction equation (4)). Sulfide is toxic and easily forms precipitates, so that the soil may clog up. Moreover, the oxidizing power of sulfate is low, which renders it a less strong electron acceptor than nitrate. Therefore, sulfate is less suitable.

Chlorine-containing compounds, specifically chlorate, can also be used as electron acceptor. Although in principle chlorate has the above-mentioned advantages of nitrate, chlorate is reduced in the soil to chlorite (ClO₂—), which is not desirable in view of its toxicity.

Surprisingly, it has also been found possible to use certain chlorinated hydrocarbons as electron acceptor. This can be advantageous specifically if soil is to be treated which, in addition to being contaminated with aromatics (in particular benzene), is also contaminated with these chlorinated hydrocarbons. This “combination contamination” often occurs in practice. These chlorinated hydrocarbons are preferably perchlororethylene, trichloroethylene, 1,2-dichloroethane, chlorophenol, chlorobenzoic acid and/or chlorobenzene. In this embodiment, it is sufficient to introduce the humic acids into the soil, since the electron acceptor is already present in it. If desired, also an additional amount of the above-mentioned electron acceptors, in particular nitrate, can be supplied.

Without wishing to be bound to any theory, it is supposed that the degradation of the aromatics according to the invention proceeds according to either of the following two hypothetical routes.

According to the first hypothetical route, it is possible that humic acids function as a so-called electron shuttle between bacterium 1 and bacterium 2 in the diagram below and where (for instance) nitrate functions as terminal electron acceptor:

| | |
|---|---|
| Bacterium 1: | |
| aromatic | → CO₂ + H₂O + e⁻ |
| oxidized humic acid + e⁻ | → reduced humic acid (*) |
| Bacterium 2: | |
| reduced humic acid (*) | → oxidized humic acid + e⁻ |
| NO₃_{^{−}} + e⁻ | → N₂ |

The asterisk (*) here indicates that the product of bacterium 1 is used by bacterium 2. Although it is plausible that more than one type of bacterium is involved in the degradation, the possibility that all processes are carried out in one type of bacterium cannot be ruled out. According to an alternative hypothetical degradation mechanism, humic acids are used as an electron donor and (for instance) nitrate as electron acceptor:

| Bacterium | |
|---|---|
| Aromatic + | → CO₂ + H₂O + |
| reduced humic acid | oxidized humic acid + e⁻ |
| NO₃_{^{−}} + e⁻ | → N₂ |

In this case, the humic acids provide for the induction of enzymes that are involved in the degradation of benzene. This second hypothetical degradation mechanism is also plausible, because humus contains many aromatic molecules. It is conceivable that enzymes that degrade the aromatics in humus are not specific and are additionally capable of converting other aromatics, such as benzene.

Not excluded is the possibility that in the humic acid mixture, components are present that are necessary as vitamin for the biosynthesis of enzymes of the anaerobic hydrocarbon-degrading bacteria.

It has been found that also in the absence of humic acids, all ingredients remain in solution, without necessitating the use of a chelating agent.

The invention can be very suitably used for cleaning soils and groundwater contaminated with aromatic hydrocarbons. Examples of very appropriate locations of use are locations where mineral oil has been extracted or stored, the petrochemical industry, chemical industrial locations where benzene is used in production processes, and (former) gas stations.

Very suitably, the invention can be used for the degradation of benzene. This is surprising, since it is generally supposed that benzene is the most notorious of all aromatic soil contaminants, that is, most difficult to break down (see, for instance, Suarez and Rifai, Bioremediation Journal 3(4)(1999) 337-362).

In addition to benzene, according to the invention, other aromatics such as BTEX (benzene, toluene, ethylbenzene and/or xylene), polycyclic aromatic hydrocarbons (PAHs), in particular naphthalene and phenanthrene, can be degraded very effectively. Also substituted aromatics, in particular chlorinated aromatics, can be degraded according to the invention. Highly eligible for degradation according to the invention are chlorinated benzenes, in particular monochlorobenzene.

The present invention can also be used for stimulating the anaerobic degradation of aliphatic hydrocarbons, including alkanes and alkenes. Alkanes and alkenes are the most important components of oil and are typically present as combination contamination with aromatic hydrocarbons. Preferably, the soil-contaminating aromatic hydrocarbons according to the invention comprise BTEX.

In principle, the invention can be used for degrading all aromatic compounds, including the aromatics (that is, hydrocarbons having at least one benzene ring) listed in the so-called blacklist published by the Ministry of Health, Regional Development and the Environment (“Target Values and Intervention Values in Soil Remediation”, Dutch Government Gazette, No. 39, 24 Feb. 2000, pp. 8-16), which list is understood to be incorporated herein.

The term “humic acids”, according to the conventional definition, refers to the water-soluble fraction of organic acids present in humus, or to the salts (for instance the sodium salts) of these acids. The humic acids that are used according to the invention can be used in different forms. Thus, it is possible to use purified humic acids, which can be obtained, for instance, through extraction of humus-rich products. An advantage of the use of (partly) purified humic acids is that, as a result, a concentrated solution can be obtained, so that less liquid needs to be injected. The humic acid can be used in the acid form or as a salt. Although a solution is normally easy to dose, it is also possible to make a powder mixture of the humic acid and the electron acceptor, and to introduce this into the soil in powder form, or optionally as slurry. In this way, a very high concentration of humic acid and electron acceptor can be achieved.

In addition, it is possible to use the humic acid in the form of compost, humus-rich percolate and/or vegetable material. An advantage of such humic acid-rich products is that they are cheaper.

As nitrate, for instance sodium, potassium or ammonium nitrate is used. Sodium and potassium nitrate enjoy preference because these are cheaper. Moreover, ammonium nitrate (fertilizer) is explosive and working with it is not always to be preferred in areas that are contaminated with the normally easily flammable aromatic compounds.

The amount of humic acid and nitrate is preferably selected such that the concentration of humic acid in the location to be remediated is 0.1-10 g/(liter of soil), more preferably 0.2-2 g/dm³, and the concentration of nitrate (or other suitable electron acceptor) is 1-100 mM, more preferably 5-50 mM (likewise based on the volume of soil). However, these concentrations may vary from one practical case to another.

Working at a high concentration of humic acids and nitrate (or other electron acceptors) has as an additional advantage that a larger volume can be treated per injection point. Even if the concentration directly around the injection point is so high as to be locally toxic to the microorganisms, this still offers an advantage: through diffusion a gradient will arise in the concentration of the injected substances, which gradient decreases in the direction away from the injection point. As a result, a larger “cloud” (that is, an area of a larger volume) can be treated.

The relative weight ratio of humic acid/electron acceptor (based on sodium nitrate as electron acceptor) in a mixture according to the invention is preferably about 2.

The invention further relates to a mixture comprising an aqueous solution of humic acid and nitrate. Preferably, such a mixture contains 1-10 wt. % of humic acid and 2-20 wt. % of nitrate (expressed as sodium nitrate), more preferably 5-10 wt. % of humic acid and 10-20 wt. % of nitrate, in particular 7-9 wt. % of humic acid and 12-18 wt. % of nitrate. With a particular preference, the solution is as concentrated as possible. Such a mixture can be very suitable deployed in the method according to the invention. If desired, this mixture can be supplemented with additives. Suitable additives are vitamins, trace elements (Zn, Co, Cu, etc.) and/or macronutrients (S, P, Fe-sources) which improve the growth of the anaerobic bacteria. Normally, a standard vitamin mixture and/or a standard trace mixture is used, as illustrated in the examples below.

Preferably, the mixture according to the invention comprises one or more macronutrients (each preferably in amounts of 0.05-10 g/dm³), one or more trace elements (each preferably in amounts of 0.01-4 mg/dm³) and/or one or more vitamins (each preferably in amounts of 0.004-1 mg/dm³).

The macronutrients are preferably selected from (NH₄)₂SO₄, MgCl₂ 6H₂O, CaCl₂ 2H₂O, NaNO₃, KH₂PO₄, Na₂HPO₄, and combinations thereof.

The trace elements are preferably selected from EDTA, FeSO₄.7H₂O, ZnSO₄ .7H₂O, MnCl₂ .4H₂O, H₃BO₃, CoCl₂ .6H₂O, CuCl₂ .2H₂O, NiCl₂ .6H₂O, Na₂MoO₄ .2H₂O, Na₂SeO₃ .5H₂O, Na₂WO₄ .2H₂O, and combinations thereof.

The vitamins are preferably selected from para-aminobenzoic acid, folinic acid, DT-lipoic acid, riboflavin, thiamin, nicotinic acid amide, pyridoxine.HCl, pantothenate, vitamin B₁₂, biotin and combinations thereof.

According to the invention, the biological degradation of aromatics, including benzene, is stimulated and stabilized under anaerobic conditions. This provides advantages specifically in the treatment of contaminated locations at places that are difficult to treat with oxygen, such as the deep subsoil under buildings and in layers of clay and loam.

Because nitrate (or other electron acceptors) and humic acids are well soluble in water, in contrast to oxygen, it is possible to treat locations with high concentrations of aromatics. The good solubility is an important advantage of the present invention.

An additional advantage is that humic acids promote the dissolution of aromatics in water, in that humic acids have both hydrophobic and hydrophilic properties and so have a surfactant action. This promotes the dissolution of undissolved aromatics (for instance present in the soil in so-called floating layers, or in sediment layers), so that these can be degraded faster. Also aromatics that are sorbed into soil particles (for instance clay particles) can dissolve more easily by virtue of the presence of the humic acids. As a consequence, the contaminant can be broken down and/or be pumped out of the soil at an accelerated rate.

Instead of, or in addition to, the humic acids mentioned, also other compounds with a quinone structure can be used, in particular compounds that contain an anthraquinone group, such as anthraquinone-2,6-disulfate (AQDS). Like humic acids, such compounds can be used as electron shuttle by anaerobic bacteria. However, since such compounds usually have a high cost price, humic acids are preferred according to the invention.

The invention will now be elucidated in and by an example and comparative examples.

### EXAMPLES

In a laboratory set-up, in a bioreactor at 20° C. and pH 7, an anaerobic mineral culture medium of the following composition was passed through continuously (concentrations based on volume of the reactor, so-called reservoir concentrations)

| Macronutrients | | |
|---|---|---|
| (NH₄)₂SO₄ | 0.5 | g/l |
| MgCl₂.6H₂O | 0.1 | g/l |
| CaCl₂.2H₂O | 0.05 | g/l |
| NaNO₃ | 1.7 | g/l |
| KH₂PO₄ | 1.0 | g/l |
| Na₂HPO₄ | 3.5 | g/l |
| Trace elements | | |
| EDTA | 1.0 | mg/l |
| FeSO₄.7H₂O | 2.0 | mg/l |
| ZnSO₄.7H₂O | 0.1 | mg/l |
| MnCl₂.4H₂O | 0.03 | mg/l |
| H₃BO₃ | 0.3 | mg/l |
| CoCl₂.6H₂O | 0.2 | mg/l |
| CuCl₂.2H₂O | 0.01 | mg/l |
| NiCl₂.6H₂O | 0.02 | mg/l |
| Na₂MoO₄.2H₂O | 0.03 | mg/l |
| Na₂SeO₃.5H₂O | 0.03 | mg/l |
| Na₂WO₄.2H₂O | 0.03 | mg/l |
| Vitamins | | |
| para-aminobenzoic acid | 0.2 | mg/l |
| folinic acid | 0.1 | mg/l |
| DT-lipoic acid | 0.1 | mg/l |
| riboflavin | 0.2 | mg/l |
| thiamin | 0.4 | mg/l |
| nicotinic acid amide | 0.4 | mg/l |
| pyridoxine.HCL | 1.0 | mg/l |
| pantothenate | 0.2 | mg/l |
| vitamin B₁₂ | 0.2 | mg/l |
| biotin | 0.004 | mg/l |

The dilution rate was 0.17 day¹. Benzene was continuously dosed to the reactor from a concentrated anoxic (that is: oxygen free) aqueous solution with a spray pump, so that a concentration of 50-200 μM in the reactor (reservoir concentration) was obtained. In order to preclude oxygen formation by algae, the reactor vessel was darkened. In this way, a so-called chemostat culture was obtained. The reactor was inoculated with four nitrate-reducing and benzene-degrading enrichment cultures that originated from different benzene-contaminated locations in the Netherlands.

### Comparative Example 1

The above-mentioned solution was passed through the reactor together with the benzene solution mentioned. No benzene degradation could be determined.

### Comparative Example 2

The above-mentioned solution was supplemented with 5 mM acetate (reservoir concentration) and this solution was passed through the reactor together with the benzene solution in the same manner as in Comparative Example 1. Again, no benzene degradation was determined.

### Comparative Example 3

Comparative Example 2 was repeated, but now, instead of acetate, benzoate was added to the solution (reservoir concentration 5 mM). Again, no benzene degradation was determined.

### Example 1 (Invention)

Comparative Example 3 was repeated, but now, after a period of 8 days, a switch was made to a solution of 0.5 g/liter of sodium salt of humic acids (reservoir concentration, ex Sigma-Aldrich), which was dosed to the reactor as described above. The benzene concentration (measured with a gas chromatograph) decreased rapidly: the half-life was ca. 1.5 days. The table below shows the course of the benzene concentration in time:

| Time/[days] | Dosage | Benzene concentration/[μM]²⁾ |
|---|---|---|
| 0 | Nitrate/benzoate | 48.10 |
| 2.85 | Nitrate/benzoate | 51.49 |
| 7.05¹⁾ | Nitrate/benzoate | 51.38 |
| 13.86 | Nitrate/humic acids | 29.41 |
| 15.03 | Nitrate/humic acids | 20.96 |
| 16.85 | Nitrate/humic acids | 8.34 |
| 17.85 | Nitrate/humic acids | 2.47 |
| 20.84 | Nitrate/humic acids | 1.73 |
| 28.85 | Nitrate/humic acids | 0.51 |
| 30.92 | Nitrate/humic acids | 0.02 |
| 31.85 | Nitrate/humic acids | 0.01 |

¹⁾moment after which a switch was made from a solution of nitrate/benzoate to a solution of nitrate/humic acids.
²⁾nominal concentration, that is, benzene in the total system based on the liquid phase.

When subsequently nitrate was omitted from the medium, the nitrate concentration decreased, until there was no nitrate to be measured anymore. From that time, the benzene concentration in the reactor vessel increased again. After addition of nitrate, the degradation process recovered fast, resulting in complete benzene degradation within a week.

The process described in Example 1 (anaerobic benzene degradation in the presence of humic acids and nitrate) was carried out and monitored for a long time. After 18 months, still complete benzene degradation was observed under the above-mentioned conditions. Surprisingly, it was established that dosing of oxygen (O₂) led to a strong increase of the benzene concentration in the bioreactor, which indicates that the benzene degradation stimulated by humic acids and nitrate is a strictly anaerobic process.

These experiments demonstrate that the combination of humic acids/nitrate can be used for stimulating and stabilizing anaerobic degradation of aromatics.

1. A method for the anaerobic biological degradation of soil-contaminating aromatic and/or aliphatic hydrocarbons present at a contaminated location, wherein a combination of one or more humic acids, if desired as salt, and at least one electron acceptor is added to anaerobic bacterial populations.

2. A method according to claim 1, wherein said electron acceptor is selected from nitrogenous compounds, in particular nitrate, nitrite and/or N₂0; sulfate; chlorate; chlorinated hydrocarbons; and combinations thereof.

3. A method according to claim 2, wherein said electron acceptor is nitrate.

4. A method according to claim 2, wherein said electron acceptor is perchloroethylene, trichloroethylene, 1,2-dichloroethane, chlorophenol, chlorobenzoic acid and/or chlorobenzene.

5. A method according to claim 1, wherein said location is a contaminated soil and wherein said combination of humic acids and electron acceptor is introduced into the soil by means of injection.

6. A method according to claim 1, wherein said aromatic hydrocarbons comprise BTEX (benzene, toluene, ethylbenzene and/or xylene), polycyclic aromatic hydrocarbons (PAHs), aliphatic hydrocarbons (alkanes, alkenes, oil), or mixtures thereof, which hydrocarbons may or may not be halogenated.

7. A method according to claim 6, wherein said aromatic hydrocarbons comprise benzene which may or may not be chlorinated, preferably monochlorobenzene.

8. A method according to claim 1, wherein said humic acids or salts thereof are used in purified form and/or in the form of compost, humus-rich percolate and/or vegetable material.

9. A mixture of humic acid and nitrate comprising an aqueous solution of 1-10 wt. % of humic acid and 2-20 wt. % of nitrate (expressed as sodium nitrate).

10. Use of a mixture according to claim 9, for the anaerobic biological degradation of aromatic and aliphatic hydrocarbons.
